(19) United States
(12) Patent Application Publication
(10) Pub. No.: US 2025/0164448 A1
(43) Pub. Date: May 22, 2025

(54) SYSTEMS AND METHODS FOR NONLINEAR ULTRASONIC EVALUATION OF MATERIAL PROPERTIES

(71) Applicant: FBS, Inc., Bellefonte, PA (US)

(72) Inventors: Cody J. Borigo, Palmyra, PA (US); Alex Reese, Bellefonte, PA (US); Russell Love, Port Matilda, PA (US); Steven E. Owens, State College, PA (US)

(73) Assignee: FBS, Inc., Bellefonte, PA (US)

(21) Appl. No.: 18/941,512

(22) Filed: Nov. 8, 2024

Related U.S. Application Data
(60) Provisional application No. 63/600,189, filed on Nov. 17, 2023.

(51) Int. Cl. G01N 29/24; G01N 29/28; G01N 29/30; G01N 29/44

(52) U.S. Cl. CPC G01N 29/2437; G01N 29/2412; G01N 29/4481; G01N 29/28; G01N 29/30; G01N 2291/02827; G01N 2291/0289; G01N 2291/102

(57) ABSTRACT

Systems and methods for non-destructively evaluating material properties using nonlinear ultrasonic methods include a first and a second transducer configured to transmit and receive a surface wave on a structure, wherein said transducers are connected to a bracket by means of at least one pivoting joint, and wherein said bracket is connected to a force mechanism by means of at least one additional pivoting joint, and wherein said force mechanism is connected to a rigid body that is in contact with said structure. A controller in signal communication with the first and second transducers and configured to cause the first transducer to generate a surface wave in the structure and to extract at least one signal feature from the surface wave signal received by the second transducer, and wherein said controller is further configured to determine at least one material property of the structure.

### CROSS-REFERENCE TO RELATED APPLICATIONS

This application claims priority to U.S. Provisional Patent Application No. 63/600,189, filed Nov. 17, 2023, the entirety of which is incorporated by reference herein.

### FIELD

The disclosed systems and methods relate to the non-destructive evaluation of material properties of metals.

### BACKGROUND

Industry recommended practices and regulations require fitness-for-service assessments of structural components including metallic plates, pipes, and other structures. One key material property required for these evaluations, particularly if a crack or other defect is identified in the structure, is fracture toughness. Fracture toughness is a measure of a material's resistance to brittle fracture; in a material with a higher fracture toughness value, a crack is less likely to propagate under the same stress and stress intensity conditions as it would in a material with a lower fracture toughness. However, this critical fracture mechanics parameter is often unknown for legacy materials and components, and it can change depending on the usage history of a material. Furthermore, it is challenging to measure using non-destructive means, i.e., without using a sacrificial sample of material from the structure to conduct destructive laboratory testing. A non-destructive method of assessing fracture toughness for in-service metallic components would be advantageous.

The field of fracture mechanics arose in response to catastrophic failures in the transportation, power generation, and aircraft industries. Fracture mechanics enables forensic analyses and damage-tolerant designs. The presence of a flaw is an integral part of stress intensity factor, strain energy release rate, and surface energy analyses. The magnification of stress in the vicinity of a flaw is described by the stress intensity factor. In fact, the stress field is singular at the tip of a sharp crack in a linear elastic material. The localized stress is given in terms of position and the stress intensity factor, K_{I}, which is generally defined as

K_{I}=FS\sqrt{πa}
where F, S, and a are the crack geometry factor, far-field stress, and crack size respectively. The subscript/denotes that this value applies to the normal separation mode of crack growth. The practical utility of the stress intensity factor is that it can be compared to a critical value in order to predict brittle fracture, i.e., K_{I}=K_{IC} is when failure by brittle fracture occurs. The critical value is a material parameter known as the fracture toughness (K_{IC}), which is determined by destructive mechanical testing according to standards such as ASTM E399. The standards ensure that the zone in which K_{I} is computed is of appropriate size relative to specimen dimensions and the inelastic process zone. Unfortunately, replicating valid plane strain linear elastic fracture mechanics (LEFM) conditions in laboratory testing of ductile metals can require very large specimens. The development of elastoplastic fracture mechanics (EPFM) based on the J-integral circumvents the need for very large specimens. As a generalization of the strain energy release rate, the J-integral is evaluated as a path independent line integral taken around a crack tip. Laboratory standards (e.g., ASTM E1820) provide procedures to relate the critical value of the J-integral to the plane strain fracture toughness K_{IC}.

Knowing the fracture toughness of a material enables designers to limit the far field stresses such that brittle fracture does not occur. In some materials the far field stresses must be kept significantly below the yield strength in order to avoid brittle fracture. Furthermore, the fracture toughness enables determination of the critical flaw size,

$${a}_{c} = \frac{1}{π} {( \frac{{K}_{IC}}{FS} )}^{2}$$

which is crucial in fitness-for-service analyses since it indicates the minimum size of flaws that must be identified in components. While impact resistance, KV, which is easily measured destructively by notch-impact tests such as Charpy V-notch tests, provides a means to compare materials it does not directly measure fracture toughness. But there are established correlations between impact resistance and fracture toughness for specific materials. Direct measurement of fracture toughness involves loading fatigue-pre-cracked test specimens until reaching failure, while monitoring load-displacement and crack mouth opening.

Brittle fracture is a weakest-link phenomenon; it initiates at a location of high stress or low ductility. Fracture toughness is very sensitive to minor alloying additions, manufacturing, and processing conditions. Thus, steels having a small range of yield strengths can exhibit a large range of fracture toughness values. Therefore, the ability to non-destructively assess the fracture toughness of a material would be advantageous as it would provide critical information without taking the component out of service or removing a significant portion of the material for destructive testing.

One method for non-destructive testing of materials is ultrasonic testing, which utilizes high-frequency stress waves to interrogate a material for flaws or material properties. Conventional ultrasonic methods are not capable of evaluating fracture toughness, but nonlinear ultrasonic methods do have the potential to evaluate material properties such as this.

Linear features of ultrasonic wave propagation (e.g., wave speed and scattering from discontinuities) are routinely used to determine pipe wall thickness, find hidden defects like cracks and corrosion, and estimate mechanical properties like Young's modulus. Strength parameters, such as yield strength, ultimate strength, fracture toughness, and endurance limit are not generally correlated to linear ultrasound features, however nonlinear features of ultrasound have been shown to correlate with strength parameters. The inherent lattice anharmonicity of the material and contact acoustic nonlinearity, as well as the fact that wave speed is amplitude-dependent lead to self-interactions and mutual interactions that, although small, are measurable. Many nonlinear ultrasound methods leverage these interactions in the frequency domain via spectroscopy or harmonic generation (integer multiples of the excitation frequencies and their sum/difference frequencies).

Abundant experimental observations have indicated that ultrasonic nonlinearity parameters of metals are sensitive to the presence of microstructural features such as dislocations, precipitates, and microcracks, the same features that promote plastic deformation and brittle fracture. Nonlinear ultrasonic testing is based on measuring the nonlinearity (i.e., amplitude-dependence of wave speed) of a material's elastic parameters. The elastic properties of most intact materials at low strains are linear (i.e., strain invariant). The imperfections introduce relatively soft bonds within the stiffer surrounding medium at microscopic scales. The locally increased compliance of imperfect interfaces and intergranular bonds results in elastic nonlinearity at the macro-scale. As a result, if an initially (almost) linear medium such as a steel alloy is thermally aged or fatigue damaged, it will exhibit nonlinearity, even at relatively low strains caused by high-power ultrasonic testing. In other words, finite amplitude ultrasonic waves mobilize the nonlinearity of the damaged material. As a result, the measured ultrasonic signals will be distorted, resulting in, for example, the generation of higher harmonics of the input frequency.

### SUMMARY

In some embodiments, a system for non-destructively evaluating at least one material property of a structure may include a probe assembly and a controller coupled to the probe assembly. The probe assembly may include a frame, a bracket coupled to the frame, a first transducer, a second transducer, and a forcing mechanism. The first transducer may be coupled to the bracket and configured to be disposed on a surface of a structure. The second transducer may be coupled to the bracket and configured to be disposed on the surface of the structure. The forcing mechanism may be coupled to the frame and to the bracket and may be configured to apply a force to the bracket. The controller may be configured to be coupled to the probe assembly such that a processor of the controller is in signal communication with the first transducer and the second transducer. The processor may be configured to cause the first transducer to generate a surface wave in the structure when the first transducer is disposed on the surface of the structure, extract at least one signal feature from the surface wave signal received by the second transducer, and determine at least one material property of the structure based on the at least one signal feature extracted from the surface wave signal.

In some embodiments, the first transducer may be coupled to the bracket by a first joint, and the second transducer may be coupled to the bracket by a second joint.

In some embodiments, the first joint may be a first pivoting joint and may be coupled to the bracket such that the first transducer is centered above at least one first contact area between the first transducer and the structure. The second joint may be a second pivoting joint and may be coupled to the bracket such that the second transducer is centered above at least one second contact area between the second transducer and the structure.

In some embodiments, at least one of the first transducer and the second transducer may include a piezoelectric sensor and an angled wedge.

In some embodiments, the first transducer may have a bandwidth that is narrower than the bandwidth of the second transducer.

In some embodiments, the second transducer may have a center frequency that is approximately twice the center frequency of the first transducer.

In some embodiments, the forcing mechanism may include at least one of a spring and a pneumatic cylinder.

In some embodiments, the frame may be configured to be releasably coupled to a surface of the structure by at least one of a magnet, a suction device, and a clamp.

In some embodiments, the bracket may be retractable from the surface of the structure.

In some embodiments, the bracket may be configured to be locked in the retracted position until released with a switch.

In some embodiments, the material property of the structure may be at least one of a fracture toughness and a Charpy impact resistance.

In some embodiments, the material property of the structure may be at least one of, ultimate strength and yield strength.

In some embodiments, the material property of the structure may be a measure of stress-corrosion cracking.

In some embodiments, the first transducer and the second transducer may be electromagnetic transducers.

In some embodiments, a method for non-destructively evaluating at least one material property of a structure includes sequentially generating a first plurality of time-varying voltage pulses in a first transducer to generate a first plurality of surface waves in a structure to which the first transducer is coupled; detecting said plurality of surface waves with a second transducer that is coupled to the structure; extracting at least one nonlinear signal feature from a first plurality of electronic signals that correspond to the first plurality of surface waves detected with the second transducer; and correlating said at least one nonlinear signal feature with at least one material property of the structure to identify the at least one material property of the structure. Each time-varying voltage pulsing may have an amplitude that is greater than a previous time-varying voltage pulse.

In some embodiments, a method may include performing a signal quality check process. The signal quality check process may include generating a second time-varying voltage pulse in the first transducer to generate at least one second surface wave in the structure to which the first transducer is coupled; detecting said at least one second surface wave with the second transducer that is coupled to the structure; extracting at least one nonlinear signal stabilization metric from at least one second electronic signal; and confirming that said the at least one nonlinear signal stabilization metric satisfies at least one stabilization criterion. The at least one second electronic signal corresponds to the at least one second surface wave detected by the second transducer.

In some embodiments, correlating the at least one nonlinear signal feature with at least one material property of the structure may include the use of a machine learning model.

In some embodiments, a couplant may be disposed between the first transducer and the structure when the first transducer generates the first plurality of surface waves in the structure; a couplant may be disposed between the second transducer and the structure when the plurality of surface waves are detected with the second transducer.

In some embodiments, the couplant may be a mineral oil.

In some embodiments, the structure may be a calibration specimen having known material properties. A method may include repeating the method on a second structure having at least one unknown material property.

In some embodiments, a system for non-destructively evaluating at least one material property of a structure comprises a first transducer configured to generate a surface wave in a structure and a second transducer configured to detect said surface wave, wherein the first and second transducers are configured such that they are aligned with, opposed to one another, separated by a gap, and configured adjacent to a common surface of said structure; a bracket, wherein the first and second transducers are connected to said bracket by at least one pivoting joint; a mechanism for applying force to the bracket, wherein said mechanism is coupled to said bracket by at least one pivoting joint; a rigid frame, wherein the mechanism for applying force is attached to said frame and wherein said frame is configured to contact a surface of the structure; a controller in signal communication with the first and second transducers, the processor configured to cause the first transducer to generate a surface wave in the structure, extract at least one signal feature from the surface wave signal received by the second transducer, and determine at least one material property of the structure.

In some embodiments, a method for non-destructively evaluating at least one material property of a structure comprises configuring a first and a second transducer on a surface of a structure; generating a time-varying voltage pulse in the first transducer to generate at least one surface wave in a structure; detecting said at least one surface wave with the second transducer and recording at least one voltage signal with a processor; extracting at least one nonlinear signal stabilization metric from said at least one signal; confirming that said signal stabilization metric satisfies at least one stabilization criterion; sequentially generating a plurality of time-varying voltage pulses in the first transducer to generate a plurality of surface waves in a structure; detecting said plurality of surface waves with the second transducer and recording a plurality of voltage signals with a processor, wherein each time-varying voltage pulse has an amplitude greater than the previous time-varying voltage pulse; extracting at least one signal feature, including at least one nonlinear signal feature from the plurality of surface wave signals; and correlating said at least one signal feature with at least one material property of a structure.

### BRIEF DESCRIPTION OF THE DRAWINGS

FIG. 1 is an illustration of a wave transmitted through a nonlinear system.

FIG. 2 is an illustration of a surface wave in a structure.

FIG. 3 is a side view of a probe for measuring a material property in a structure.

FIG. 4 is a side view of transducers for transmitting and detecting a surface wave in a structure.

FIG. 5 is a side view of components of a probe for measuring a material property in a structure.

FIG. 6 is a schematic of a system for measuring a material property in a structure.

FIG. 7 is a block diagram of a process for measuring a material property in a structure.

FIG. 8 is a block diagram of a machine learning model.

### DETAILED DESCRIPTION

This description of the exemplary embodiments is non-limiting and is intended to be read in connection with the accompanying drawings, which are to be considered part of the entire written description.

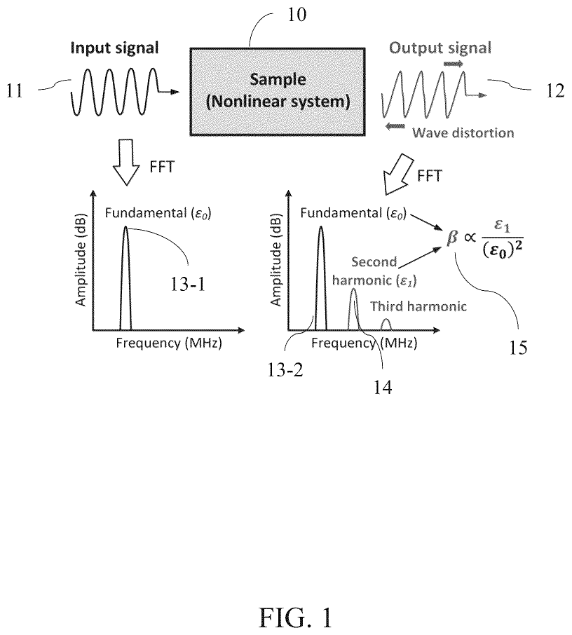

In reference to FIG. 1, a material 10 with nonlinear elastic properties distorts an ultrasonic wave such that the input signal 11 differs from the output signal 12 in terms of the relative amplitudes of the fundamental frequency component 13 (e.g., 13-1, 13-2) and the harmonic frequency component 14. These relative values can be utilized to calculate a nonlinear parameter 15 (β).

Ultrasonic measurement methods may be used for nonlinear measurements. One example of such a method is to utilize ultrasonic bulk waves propagating through the thickness of the material in a through-transmission configuration. This method uses a transmitting transducer on one surface of the material and a receiving transducer on an opposite surface. The ultrasonic energy is emitted by the transmitting transducer, propagates through the material, and is subsequently detected by the receiving transducer. However, this approach requires access to both sides of the component through the thickness of the material, which is often not feasible for in-service structures, particularly for pipes. In contrast, the disclosed systems and methods utilize ultrasonic surface-type waves, which enables the transmitting and receiving transducers to be disposed on a common (e.g., the same) surface of a material when performing nonlinear ultrasonic measurements.

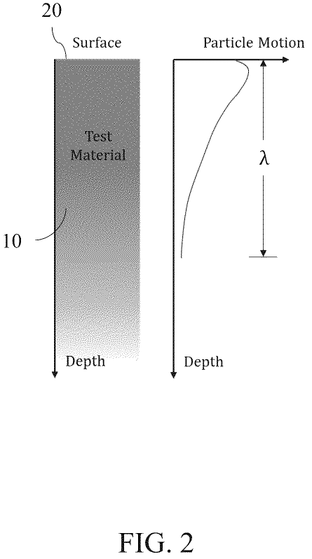

Surface waves, sometimes referred to as Rayleigh waves, are a form of guided ultrasonic waves that propagate in a material along a single free boundary, in which the material represents an approximate half-space. Surface wave velocity is a function of the Poisson's ratio, density, Young's modulus, and shear modulus in a homogenous, elastic material. In reference to FIG. 2, surface wave energy, and thus the particle motion, decreases with depth below the surface 20 of the material 10 such that it is primarily limited to a portion of the material 10 that is within one wavelength, λ, of surface 20.

Surface waves are an ultrasonic mode type and advantageously may be used for the disclosed systems and methods for several reasons:
First, a strong second harmonic can be generated at twice the fundamental frequency with Rayleigh surface waves in homogeneous materials.
Second, surface wave measurements can be performed with access from only one side of the component, which is advantageous for field measurements on pipelines and other structures. Bulk wave nonlinear measurements, which are the most common type found in the literature, generally require access to both sides of the material, which may not be practical for many applications. Bulk wave ultrasonic techniques utilizing reflections from the opposite surface of the material also may introduce complications due to variations in material thickness, surface condition, liners, product, or build-up in contact with the surface, and other factors.
Third, guided wave techniques using SH or Lamb type waves that interact with the full thickness of the material may also be sensitive to these factors associated with material thickness and the condition of the opposite surface.
Fourth, the surface wave only interacts with the material to a particular depth below the surface, with the energy decaying approximately exponentially with depth, and the penetration depth being proportional to the wavelength. This means that the material surface can be cleaned and prepared on a small test area and the results will not be influenced by the material thickness or any opposing surface conditions as the measurement is only occurring to a limited depth in the material.
Fifth, surface waves are generally nondispersive, meaning their velocity is independent of frequency; this yields a strong nonlinear response since the harmonic and fundamental waves propagate synchronously together.

In addition to the wave mode and the transducer configuration utilized for the measurement, the transducer coupling to the surface is a parameter that affects nonlinear ultrasonic testing. Since many factors outside of the material properties can affect the nonlinearity of the transmitted ultrasonic signals during a test, these other parameters are designed and/or controlled to minimize their deleterious effect on the accuracy of the measurement. Transducer coupling, or the mechanisms by which ultrasonic energy is transferred from a transducer to a material and vice versa, is one of these parameters. The disclosed systems utilize mechanisms in the probe assembly to ensure the coupling force applied to the transmitting and receiving transducers is balanced and repeatable between measurements.

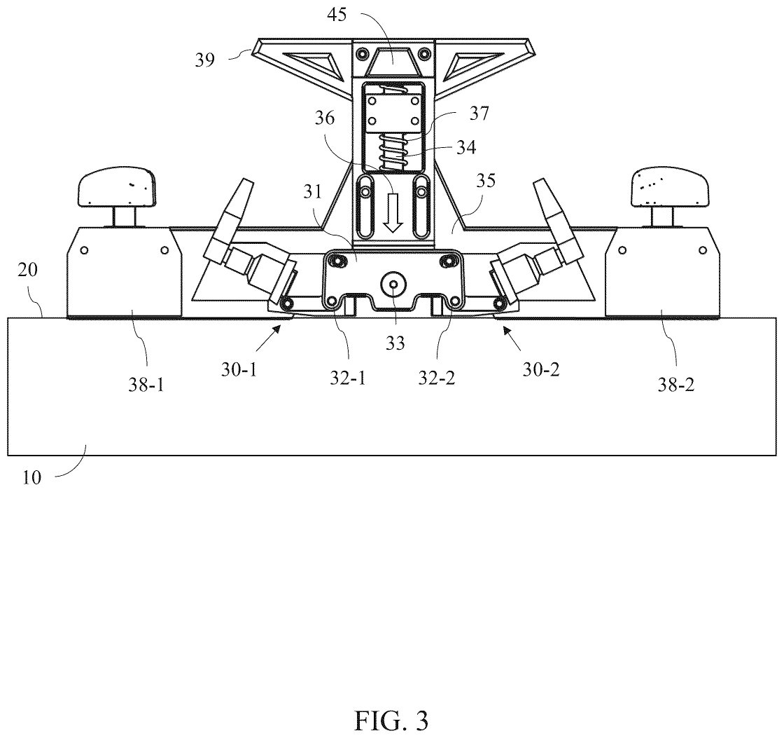

In reference to FIG. 3, in some embodiments, a first transducer 30-1 and a second transducer 30-2 may be configured such that they are aligned with and opposed are to one another. In some embodiments, the first transducer 30-1 and second transducer 30-2 may be attached to a common bracket 31 with at least one pivoting joint 32 (e.g., first and second pivoting joints 32-1 and 32-2, respectively). The bracket 31 may be further attached to a forcing mechanism 34 (e.g., a spring, piston actuator, cammed actuator, screw-drive actuator, bladder, etc.) at a third joint 33, which may be a central pivoting joint. Furthermore, forcing mechanism 34 may be rigidly attached to a frame 35 that is, in turn, braced against surface 20 such that the forcing mechanism 34 remains effectively perpendicular to said surface. This configuration ensures that the coupling force is applied perpendicularly to surface 20 of material 10 and that the transducers 30 are able to pivot to accommodate any imperfections or unevenness of said surface.

In some embodiments, a coupling force 36 may be applied to forcing mechanism 34 by one of a spring 37 or a pneumatic cylinder, and a rigid frame 35 may be retained against surface 20 by at least one magnet 38, at least one suction device, or at least one clamp. It should be understood that other retention devices or mechanisms may be implemented beyond at least one magnet, suction device, and/or clamp.

In some embodiments, bracket 31 may be retractable from surface 20 to facilitate the application of a liquid couplant to the surface. The bracket 31 may be retracted by compressing spring 37 by pulling a handle 39 attached to rigid frame 35. In some embodiments a locking mechanism, such as a detent, latch, or other suitable mechanism, may be configured to maintain the bracket 31 in the retracted position until manually released. In some embodiments, the locking mechanism may include a spring-loaded catch configured to be deployed when the bracket is in the retracted position and spaced from the surface 20. A button 45 may be configured to retract the spring-loaded catch to release the bracket 31 from the engagement with the locking mechanism.

In some embodiments, the first transducer 30-1 may be a narrowband transmitting transducer having a center frequency on the order of 2.25 MHZ, and the second transducer 30-2 may be a broadband receiving transducer having a center frequency on the order of 4.5 MHz. The transmitting transducer may be narrowband to maximize the energy in the fundamental frequency band. The receiving transducer may be broadband having a center frequency approximately twice that of the transmitting transducer to facilitate measurement of the frequency components in the fundamental frequency band and the second harmonic. One of ordinary skill in the art will understand that other center frequencies may be used for the transducers 30.

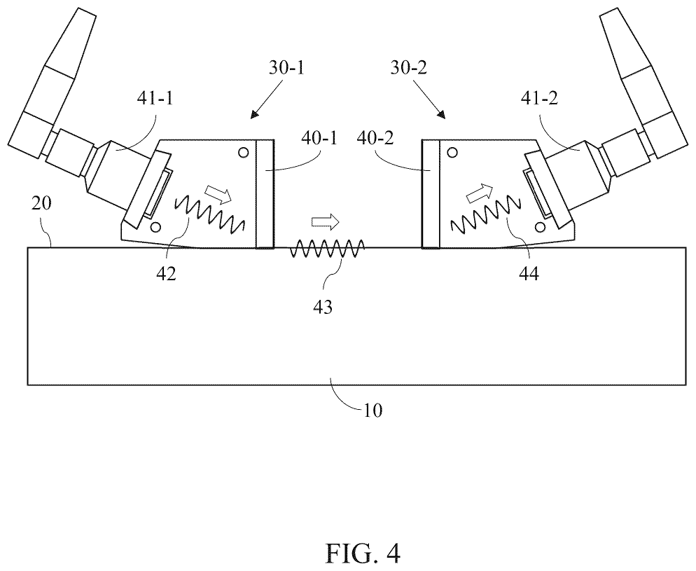

In reference to FIG. 4, in some embodiments, the first transducer 30-1 may include a first piezoelectric sensor 41-1 and a first angled acrylic wedge 40-1 configured to refract the longitudinal ultrasonic wave 42 emitted by said sensor such that a surface wave 43 is generated in material 10. The second transducer 30-2 may include a second piezoelectric sensor 41-2 and a second angled acrylic wedge 40-2 configured to refract the ultrasonic surface wave energy 43 such that it propagates through wedge 40-2 as longitudinal wave 44 and is detected by the second sensor 41-2. The first sensor 41-1 may be ultrasonically coupled to the first wedge 40-1, and the second sensor 41-2 may be ultrasonically coupled to the second wedge 40-2, and both wedges may be ultrasonically coupled to surface 20 of material 10 by means of a liquid couplant. It will be understood by those of ordinary skill in the art that the wedge material may be substituted for a variety of materials and that the appropriate angle of the wedges is determined based on the surface wave speed in the material, the longitudinal wave speed in the wedge according to Snell's Law, which states that the ratio of the sines of the angle of incidence and the angle of refraction is equal to the ratio of the wave speeds in the material of incidence and material of refraction. For example, if a surface wave (θ₂=90° refraction) is to be generated in carbon steel (surface wave speed c₂ of approximately 3000 m/s) using an acrylic wedge (longitudinal wave speed c₁ of approximately 2,700 m/s), then the calculation of the incident wedge angle θ₁ is provided below.

$${θ}_{1} = {sin}^{- 1} ( \frac{{c}_{1}}{{c}_{2}} \cdot sin ( {θ}_{2} ) ) = {sin}^{- 1} ( \frac{2700}{3000} \cdot sin ( 90 ° ) ) = 64 °$$

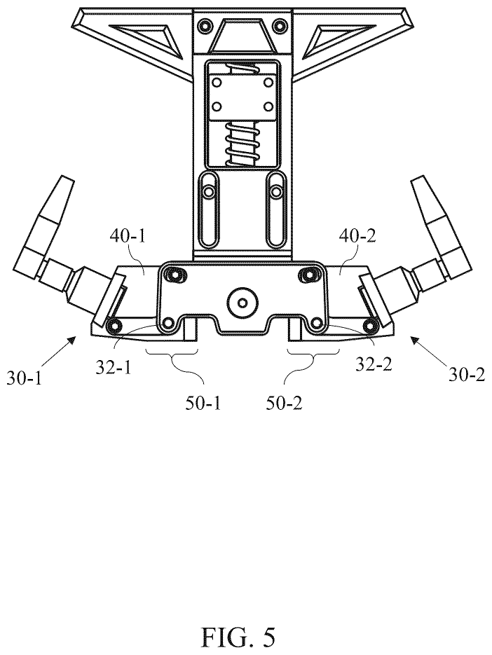

In reference to FIG. 5, in some embodiments, the first and second pivoting joints 32-1 and 32-2 are configured such that they are centered above the first and second contact areas 50-1 and 50-2 of the first and second angled wedges 40-1 and 40-2, respectively.

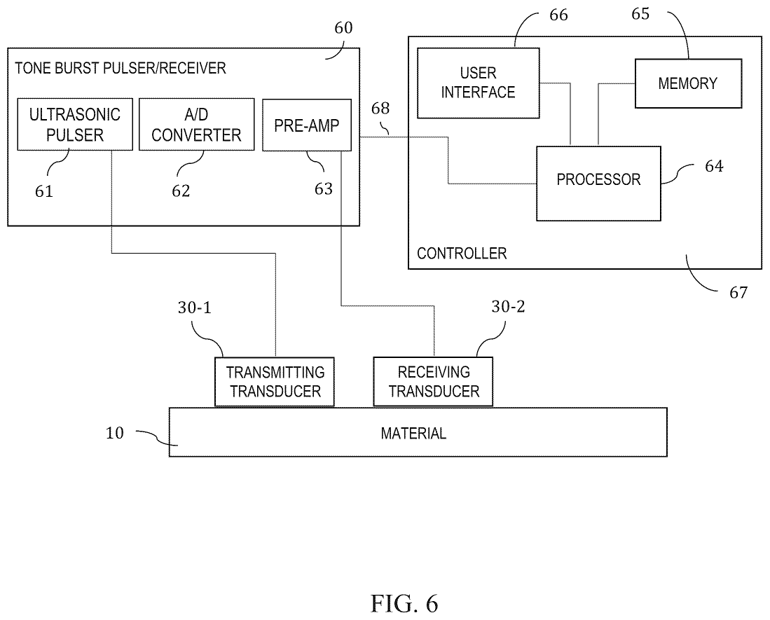

In reference to FIG. 6, a schematic illustration of one embodiment of a system for nonlinear ultrasonic material property evaluation is provided. In this embodiment, processor 64 and tone burst pulser/receiver 60 are configured to generate a time-varying voltage applied to transmitting transducer 30-1. Processor 64 and pulser/receiver 60 may be further configured to detect time-varying voltage at receiving transducer 30-2. The ultrasonic signals detected by transducer 30-2 may be amplified by pre-amplifier 63 and digitized by analog-to-digital (A/D) converter 62. The digitized data may be transmitted to a processor 64, by means of a communication interface 68, where they may undergo further signal processing by said processor, as will be understood by one of ordinary skill in the art.

Controller 67 may include a processor 64, memory 65, and user interface 66. The waveform data may be recorded by a machine-readable storage medium (memory) 65. User information may be provided to the processor, and measurement information may be provided to the user, via user interface 66. Examples of user interface 66 include a keyboard, keypad, mouse, trackball, and touchscreen, to list only a few possible examples. In some embodiments, a display (not shown) may be coupled to the controller 67 for displaying information to a user. In some embodiments, the display may be a touchscreen display such that the display is part of the user interface 66.

Controller 67 includes a processor 64, which may be any central processing unit (“CPU”), microprocessor, micro-controller, or computational device or circuit for executing instructions. Various software embodiments are described in terms of this exemplary processor. After reading this description, it will be apparent to one of ordinary skill in the art how to implement the method using other computer systems or architectures.

Controller 67 also may include a memory 65, which may further include a main memory, such as a random-access memory (“RAM”), and a secondary memory. In some embodiments, the secondary memory may include a persistent memory such as, for example, a hard disk drive and/or removable storage drive, representing an optical disk drive such as, for example, a DVD drive, a Blu-ray disc drive, or the like. As will be understood by one of ordinary skill in the art, memory 65 may include a non-transient machine-readable storage medium having stored therein computer software and/or data.

In an embodiment where the method is implemented using software, the software may be stored in a computer program product and loaded into controller 67 using a removable storage drive, hard drive, or communications interface. The software, when executed by a processor 64, causes said processor to perform the functions of the methods described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

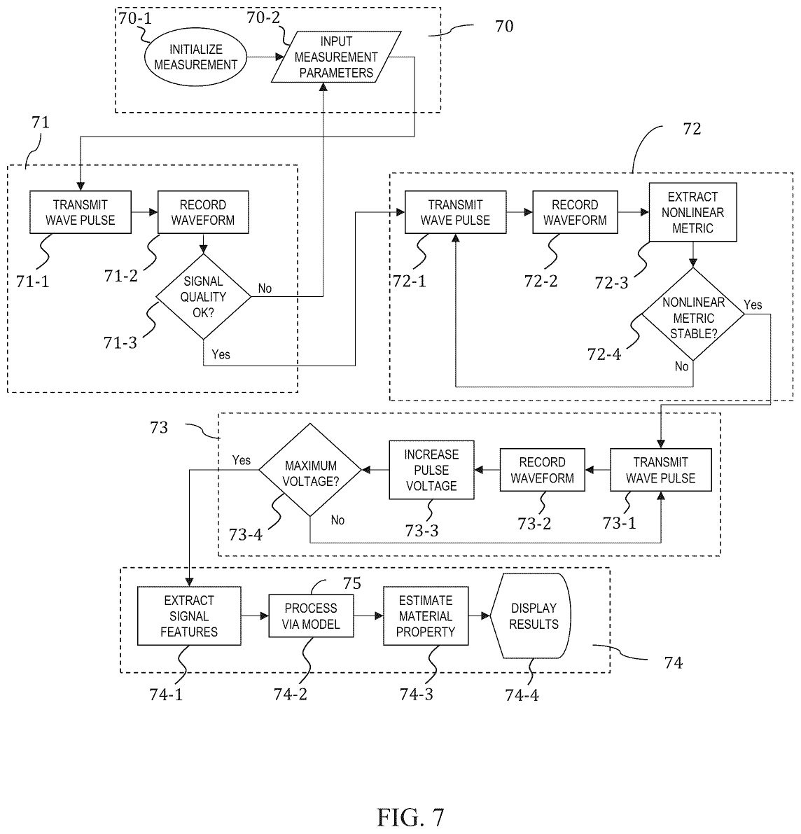

In reference to FIG. 7, a block diagram of one embodiment of a nonlinear ultrasonic material property measurement algorithm includes an initialization process 70, a signal quality check process 71, a signal stabilization check process 72, a data collection process 73, and data processing and display process 74.

The initialization process 70 may include one or more sub-processes. For example, in some embodiments, the initialization process 70 may include powering up and clearing memories to initialize the system for measurement at sub-process 70-1. The initialization process 70 also may include a sub-process 70-2 in which the system receives input measurement parameters at sub-process 70-2. The measurement input parameters, which may include pulse frequency, pulse duration, synchronous averaging, sampling rate, and various other parameters, may be loaded by processor 64 from memory 65 and/or may be received from a user via user interface 66.

Following the initialization process 70, the signal quality check process 71 may be performed. The signal quality check process 71 may include a number of sub-processes, such as a transmit wave pulse sub-process 71-1, record waveform sub-process 71-2, and a signal quality assessment sub-process 71-3. At transmit wave pulse sub-process 71-1, a wave pulse 43 (FIG. 4) may be transmitted from transducer 30-1 to transducer 30-2. The waveform received by transducer 30-2 may be recorded and stored in memory 65 at record waveform sub-process 71-2, and the waveform may be processed by processor 64 at signal quality assessment sub-process 71-3 to evaluate whether a predetermined set of signal quality metrics are satisfied. Said quality metrics may include at least one of a minimum signal amplitude, maximum noise level, and confirmation that voltage saturation of A/D converter 62 is not occurring. If the metrics are not satisfied, the user may be prompted to adjust the test setup or settings. If the metrics are satisfied, the algorithm may proceed to the signal stabilization check process 72.

In stabilization check 72, the system may execute a number of sub-processes, such as a transmit wave pulse sub-process 72-1, a record waveform sub-process 72-2, an extract nonlinear metric sub-process 72-3, and a nonlinear analyze sub-process 72-4. The transmit wave pulse sub-process 72-1 may be similar to transmit wave pulse sub-process 71-1 in that a wave pulse 43 may be transmitted from transducer 30-1 to transducer 30-2. In the same way, the record waveform sub-process 72-2 may be similar to the record waveform sub-process 71-2. At extract nonlinear sub-process 72-3, the recorded waveform may be processed by processor 64 to extract at least one nonlinear signal metric, which may be tracked over repeated iterations of pulsing and receiving until it is determined that said metric is changing within a maximum allowable amount over successive cycles. Examples of nonlinear signal metrics include the second or third harmonic frequency components of the signal, ratios of said harmonics to the fundamental frequency component, and various algebraic or arithmetic combinations of said frequency component and said ratios. At the nonlinear analyze sub-process 72-4, the data obtained during the extract nonlinear metric sub-process 72-3 is analyzed to determine whether the metric is stable. If the nonlinear metric is not stable, process 72 repeats until stabilization occurs or a maximum time-out duration is reached. If the nonlinear metric is stable, the algorithm may proceed to data collection process 73. The stability of the nonlinear metric may be determined by confirming that said metric does not change by a specified percentage on average over a specified time interval, e.g., if the ratio of the second harmonic frequency content to the fundamental frequency content varies by less than ±5% over the course of a 10-second interval, the metric is considered to be stable. One of ordinary skill in the art will understand that other percentages may be used to assess whether the metric is stable.

Data collection process 73 also may include a number of sub-processes. For example, the data collection process 73 may include a transmit wave pulse sub-process 73-1, a record waveform sub-process 73-2, an increase pulse voltage sub-process 73-3, and a voltage analysis sub-process 73-4. In the transmit wave pulse sub-process 73-1 of the data collection process 73, a wave pulse 43 may be transmitted from transducer 30-1 to transducer 30-2 in the same or a similar way to the transmit wave pulse sub-process 71-1. The record waveform sub-process 73-2 also may be similar to the record waveform sub-process 71-2, as the waveform may be processed and recorded to memory by processor 64. At increase pulse voltage sub-process 73-3, the pulser voltage applied by ultrasonic pulser 61 may be increased by a predetermined increment and the wave transmission sub-processes (e.g., transmit wave pulse sub-processes 73-1 and record waveform sub-process 732-2) may be repeated. This process may continue until the ultrasonic pulse 61 has reached its maximum pulse voltage as determined by processor 64 during the voltage analysis sub-process 73-4, at which point the algorithm may proceed to the data processing step 74.

Data processing process 74 may include one or more sub-processes, such as an extract signal features sub-process 74-1, a process via model sub-process 74-2, an estimate material property sub-process 74-3, and an output results sub-process 74-4. In the extract signal features sub-process 74-1 of data processing process 74, the data set may be processed by processor 64 to extract a set of at least one nonlinear signal feature and, in some embodiments, at least one linear signal feature. Said features may include those in the time domain and frequency domain and may include features extracted from a single waveform or extracted by processing a set of waveforms collected at multiple voltage pulsing levels. Several examples of signal features include signal amplitude, wave velocity, relative amplitudes of frequency components in the frequency spectrum, changes in signal amplitude as a function of pulse voltage, changes in frequency component amplitudes as a function of pulse voltage, and changes in ratios of other features as a function of pulse voltage. Those or ordinary skill in the art will understand that these are examples of relevant signal features and this is not an all-encompassing list.

In process via model sub-process 74-2, the extracted signal features may be processed through a model, such as a machine learning model as described below, and the output of the model may be used in the estimate material property sub-process 74-3 to generate an estimated material property value. At output results sub-process 74-4, the estimated material property may be displayed for the user via user interface 66 and/or saved to memory 65.

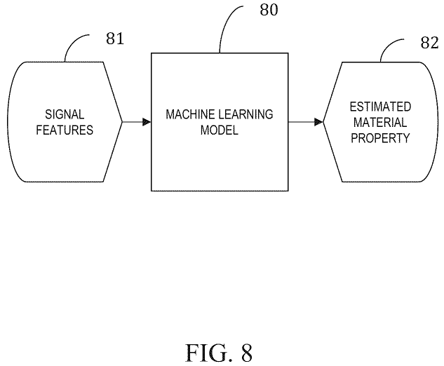

In reference to FIG. 8, a set of signal features 81 may be inputs to a machine learning model 80 used to generate an estimated material property 82. In some embodiments, machine learning model 80 may be a trained model developed using machine learning or artificial intelligence methods including, but not limited to, one of a linear regression, a gaussian process regression, a gradient boosting algorithm, and a neural network. Machine learning models are generally developed by processing sets of training and testing data, evaluating the quality of the predictions based on known values, and repeating this process in order to iteratively improve the accuracy of said model. The various types of machine learning models and various processes for training and evaluating such models will be understood by those of ordinary skill in the art.

In one embodiment, the machine learning model 80 may be trained to predict fracture toughness of the material 10. In alternate embodiments, model 80 may be trained to evaluate at least one of Charpy impact energy, material microstructure, early-stage stress-corrosion cracking, yield strength, and ultimate strength. Those of ordinary skill in the art will understand that the machine learning model 80 can be trained to predict material properties that are intrinsically linked to the same microstructural characteristics that affect the material's elastic nonlinearity, which will in turn affect the transmitted ultrasonic wave.

The foregoing outlines features of several embodiments so that those skilled in the art may better understand the aspects of the present disclosure. Those of ordinary skill in the art should appreciate that they may readily use the present disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A system for non-destructively evaluating at least one material property of a structure, comprising:
a probe assembly, the probe assembly including:
a frame;
a bracket coupled to the frame;
a first transducer coupled to the bracket and configured to be disposed on a surface of a structure;
a second transducer coupled to the bracket and configured to be disposed on the surface of the structure;
a forcing mechanism coupled to the frame and to the bracket, the forcing mechanism configured to apply a force to the bracket;
a controller configured to be coupled to the probe assembly such that a processor of the controller is in signal communication with the first transducer and the second transducer, the processor configured to:
cause the first transducer to generate a surface wave in the structure when the first transducer is disposed on the surface of the structure;
extract at least one signal feature from the surface wave signal received by the second transducer; and
determine at least one material property of the structure based on the at least one signal feature extracted from the surface wave signal.

2. The system of claim 1, wherein the first transducer is coupled to the bracket by a first joint, and wherein the second transducer is coupled to the bracket by a second joint.

3. The system of claim 2, wherein:
the first joint is a first pivoting joint and is coupled to the bracket such that the first transducer is centered above at least one first contact area between the first transducer and the structure; and
the second joint is a second pivoting joint and is coupled to the bracket such that the second transducer is centered above at least one second contact area between the second transducer and the structure.

4. The system of claim 2, wherein at least one of the first transducer and the second transducer comprises a piezoelectric sensor and an angled wedge.

5. The system of claim 1, wherein the first transducer has a bandwidth that is narrower than the bandwidth of the second transducer.

6. The system of claim 5, wherein the second transducer has a center frequency that is approximately twice the center frequency of the first transducer.

7. The system of claim 1, wherein the forcing mechanism includes at least one of a spring and a pneumatic cylinder.

8. The system of claim 1, wherein the frame is configured to be releasably coupled to a surface of the structure by at least one of a magnet, a suction device, and a clamp.

9. The system of claim 1, wherein the bracket is retractable from the surface of the structure.

10. The system of claim 9, wherein the bracket is configured to be locked in the retracted position until released with a switch.

11. The system of claim 1, wherein the material property of the structure is at least one of a fracture toughness and a Charpy impact resistance.

12. The system of claim 1, wherein the material property of the structure is at least one of, ultimate strength and yield strength.

13. The system of claim 1, wherein the material property of the structure is a measure of stress-corrosion cracking.

14. The system of claim 1, wherein the first transducer and the second transducer are electromagnetic transducers.

15. A method for non-destructively evaluating at least one material property of a structure, comprising:
sequentially generating a first plurality of time-varying voltage pulses in a first transducer to generate a first plurality of surface waves in a structure to which the first transducer is coupled, each time-varying voltage pulsing having an amplitude that is greater than a previous time-varying voltage pulse;
detecting said plurality of surface waves with a second transducer that is coupled to the structure;
extracting at least one nonlinear signal feature from a first plurality of electronic signals that correspond to the first plurality of surface waves detected with the second transducer; and
correlating said at least one nonlinear signal feature with at least one material property of the structure to identify the at least one material property of the structure.

16. The method of claim 15, further comprising performing a signal quality check process, the signal quality check process comprising:
generating a second time-varying voltage pulse in the first transducer to generate at least one second surface wave in the structure to which the first transducer is coupled;
detecting said at least one second surface wave with the second transducer that is coupled to the structure;
extracting at least one nonlinear signal stabilization metric from at least one second electronic signal, the at least one second electronic signal corresponding to the at least one second surface wave detected by the second transducer; and
confirming that said the at least one nonlinear signal stabilization metric satisfies at least one stabilization criterion.

17. The method of claim 15, wherein correlating the at least one nonlinear signal feature with at least one material property of the structure includes the use of a machine learning model.

18. The method of claim 14, wherein:
a couplant is disposed between the first transducer and the structure when the first transducer generates the first plurality of surface waves in the structure; and
a couplant is disposed between the second transducer and the structure when the plurality of surface waves are detected with the second transducer.

19. The method of claim 18, wherein the couplant is mineral oil.

20. The method of claim 14, wherein the structure is a calibration specimen having known material properties, the method comprising repeating the method on a second structure having at least one unknown material property.
